(19) United States
(12) Patent Application Publication
(10) Pub. No.: US 2011/0167007 A1
(43) Pub. Date: Jul. 7, 2011

(54) SYSTEM AND METHOD FOR TASK MANAGEMENT

(76) Inventor: CHRIS SAITTA, Rancho Palos Verdes, CA (US)

(21) Appl. No.: 12/683,999

(22) Filed: Jan. 7, 2010

(51) Int. Cl. G06Q 10/00

(52) U.S. Cl. 705/301

(57) ABSTRACT

The present invention provides systems and methods for managing the delegation of tasks. Various embodiments of the invention provide a delegation management framework capable of real-time oversight, workflow compliance and business rule compliance of individual or groups of tasks under the control of the framework. In some embodiments, a delegation management system is provided, comprising: a marketplace in which a first party can create a task and assign the task to a second party, whereby the second party can review the task, respond to the task, and accept the task; a workflow engine configured to ensure that processes for creating, assigning, reviewing, responding to, or accepting the task are performed in accordance with a predefined workflow; and a rules engine configured to apply a predefined business rule to decisions within the marketplace regarding the task.

### FIELD OF THE INVENTION

The present invention relates to delegation management, and more particularly, some embodiments relate to system and methods for delegation of tasks within the context of business process outsourcing.

### DESCRIPTION OF THE RELATED ART

To save time and money during sudden increases in transactional volume, many companies often outsource their business processing. Frequently, however, outsourcing results in a lack of oversight and control, which can pose real business risks and problems for compliance. For example, such is the case with methods for managing mortgage foreclosures. Within the context of property foreclosures, the foreclosed property usually requires maintenance and/or services as the property is in the process of being resold. Traditionally, to handle needs of a foreclosed property as it is readied for selling, a mortgage holder or foreclosure manager enlists the aid of one or more vendors (e.g., plumbers, pest controllers, roofers, painters, pool maintainers, electricians, floor maintainers, rug providers, gardeners, landscapers, general contractors, etc.) to provide the maintenance or service on the property. In other cases, the mortgage holder or foreclosure manager enlists the services of an intermediary party who contracts out the maintenance or services to vendors on behalf of the mortgage holder or foreclosure manager. For this type of outsourcing, the mortgage holder or foreclosure manager maintains oversight and management over the services rendered through direct contact with the vendors or the intermediary parties. In doing so, it becomes increasingly difficult to manage the maintenance and services of a foreclosed property, especially as the number and volume of property foreclosures increases.

### BRIEF SUMMARY OF EMBODIMENTS OF THE INVENTION

The present invention provides systems and methods for managing delegation of tasks. According to some embodiments, a delegation management system is provided, comprising: a marketplace within which a first party can create a task and assign the task to a second party, wherein the second party can review the task, respond to the task, and accept the task; a workflow engine that ensures processes for creating, assigning, reviewing, responding to, or accepting the task within the marketplace are performed in accordance with a predefined workflow; and a rules engine that applies a predefined business rule to decisions within the marketplace regarding the task. In some embodiments, the response comprises a bid submitted with respect to a task.

Depending on the embodiment's implementation and use, the first party may be, for example, an intermediary party working on behalf of a primary party (e.g., mortgage holder, foreclosure manager) to manage and complete specific tasks. Additionally, the second party may be, for example, a vendor (e.g., plumber, pest controller, roofer, painter, pool maintainer, electrician, floor maintainer, carpenter, lawn maintainer, gardener, landscaper or general contractor) who is contracted by the first party to perform the specific tasks. Furthermore, in some embodiments, the primary party has the ability to review the task status or progress through the delegation management system.

In additional embodiments, the first party connects to the marketplace through a primary workstation through which the first party can create a task or can assign the task. In other embodiments, the second party connects to the marketplace through a subordinate workstation through which the second party can review the task, respond to the task or accept the task. Additionally, for some embodiments, the first party can add, delete, or modify a business rule. In further embodiments, the first party can add, delete, or modify a predefined workflow.

In some embodiments, if the second party completes a process outside the predefined workflow or outside the business rule, a request for approval of the process is sent to the first party.

In various embodiments, one or more tasks within the delegation management system can be associated with a real property or a portfolio of real properties. In some such embodiments, the delegation management system further comprises: a listing module configured to receive a record of a real property, wherein the record represents a real property; and a task module configured to manage a task associated with a real property, wherein the first party can create and assign the task associated with the real property.

In some embodiments, the delegation management system may further comprise a response module configured to accept a response from the second party, wherein the response is associated with the task and the first party responsible for the task may either accept or decline the response. Optionally, the first party can assign the task to the second party, whereby the second party can either accept or decline. Other embodiments may further comprise a task module configured to maintain a task status for a task, wherein the task status can be updated by the first party assigned to the task or the second party assigned to the task.

In other embodiments, the delegation management system may further comprise a payment module configured to track approval of funds and marking of funds for transfer to the second party upon a predetermined condition related to the task. For example, in some such embodiments, the condition for approval of a fund transfer to the second party could be conditioned on the completion of a task related to a real property.

Various embodiments may be configured to accept media associated with the task (e.g., pictures of the real property before and after a task is completed). Additionally, particular embodiments may be configured to provide a secure message system between parties.

In further embodiments, the delegation management system may further comprise an authentication module that is configured to: determine whether a party can access, edit, delete or add a record on the delegation management system; allow the first party access to only records relating to a real property to which the first party is assigned; and allow the second party access only to records relating to a task to which the second party is assigned. In yet further embodiments, the first party is able to rate the second party upon the performance of the task (e.g., upon completion of an assigned task).

According to further embodiments, various operations described above are implemented using a computer. For example, some embodiments provide for a computer program product comprising a computer useable medium having computer program code embodied therein for controlling a user interface in a computing environment in accordance with aspects of the invention as described herein.

In additional embodiments, a computer program product having instructions embedded in a computer useable medium is provided, the instructions configured to cause a processor to perform the operations of: receiving a record of a real property from a primary party; storing the record on a computer useable medium; assigning the record to a first party; receiving a request for a task from the first party, wherein the task is associated with the record; listing the task such that a second party can respond to the task; receiving a response from the second party on the task; forwarding the response to the first party for review; receiving an acceptance or rejection of the response from the first party; and storing the acceptance or rejection on a computer usable storage medium. Optionally, if the response is accepted and the second party meets a predetermined condition related to the task, funds may be automatically transferred to the second party upon meeting the predetermined condition.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a flowchart of an example method for delegation management in accordance with an embodiment of the present invention.

FIG. 2 illustrates a diagram of an example system for delegation management in accordance with an embodiment of the present invention.

FIG. 3 illustrates a flowchart of an example workflow under which a delegation management system can operate in accordance with an embodiment of the present invention.

FIG. 4 illustrates an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for delegation of tasks within the context of business process outsourcing. Various embodiments of the invention provide a delegation management framework capable of real-time oversight, workflow compliance and business rule compliance of individual tasks or groups of tasks under the control of the framework. For example, an embodiment of the present invention could provide a single platform for communication between a plurality of intermediary parties (also known as midsourcers), vendors, and mortgagors, which enables every mortgagor to assign maintenance and servicing of a foreclosure property to an intermediary, and to know in real-time what each intermediary and associated vendor is doing on the mortgagor's foreclosure property. In addition, such an embodiment may also enable selection of real estate listing agents when the foreclosed property is ready for sale, a process which may be managed by the intermediary on behalf of the mortgagor. Furthermore, an intermediary cannot see real properties (i.e., real estate) that are either retained by the mortgagor or designated to another intermediary.

For some embodiments, the framework comprises a marketplace in which parties can create, delegate, and oversee tasks. In some such embodiments, parties communicate with the marketplace through one or more workstations that connect to the marketplace. In some embodiments, the marketplace is a private and secure network maintained within the framework. Additionally, the framework may comprise components that ensure processes performed and decisions made within the framework follow predefined business decision rules and predefined (process) workflows. Such predefined rules and workflows enforce a desirable business logic to transactions taking place within the marketplace.

In some embodiments, a primary (or master) workstation can control business processes within the framework by adding, deleting, or modifying workflows. The primary workstation can additionally control business decisions within the framework by adding, deleting or modifying business (decision) rules; and control service provider (e.g., vendor, contractor) selection. Accordingly, the workflows ensure that users within the marketplace follow the correct processes, and the business rules ensure that all decisions are in compliance with the defined business logic.

Through a primary workstation, a primary party (e.g., mortgage holder, foreclosure holder) can control how tasks are delegated and performed on the primary party's behalf. The primary workstation also provides a primary party to view the status or progress of the tasks they have assigned (i.e., delegated) to a first party (e.g., intermediary party) in real-time. In some embodiments, the primary party is able to assign specific tasks to specific first parties.

Subordinate workstations may be utilized in some embodiments to provide first parties (e.g., intermediary parties) and second parties (e.g., vendors) access to the marketplace, but only to the extent that the first and second parties' transactions taken through the subordinate workstations comply with defined workflows and business rules. For example, a first party may only see transaction processes (e.g., tasks) assigned to it by a primary party.

For some embodiments, if ever the first or second party performs or completes a process outside the parameters set by the workflow or business rules, such a process is submitted to the primary party for approval. The primary party, in turn, could then approve or disapprove of the nonconforming process.

For some embodiments, the framework is further configured to transfer static and dynamic data formats between non-analogous systems, such as a service provider's proprietary system. Static data formats have a static data path from the source to the destination, whereas a dynamic data format has a data path based on conditions. Through such flexibility, various embodiments of the invention can, for example, connect and interact with systems non-analogous with respect to the framework.

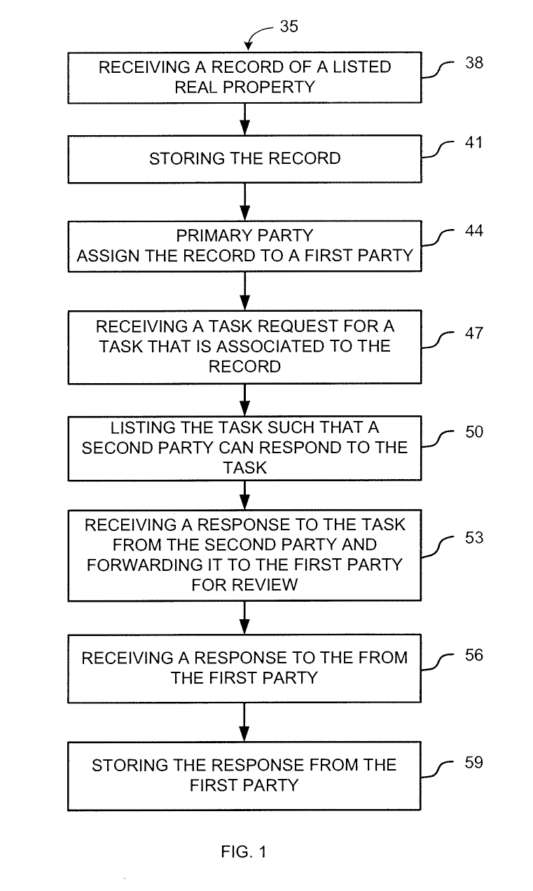

FIG. 1 illustrates a flowchart of an example method 35 for delegation management in accordance with an embodiment of the present invention. Specifically, the FIG. 1 demonstrates an example method that can be utilized in managing tasks related to one or more real properties. For example, the method 35 could be utilized in management of tasks related to foreclosure property. Method 35 involves a primary party (e.g., mortgage holder, foreclosure manager), a first party (e.g., intermediary party) and a second party (e.g., vendor).

Referring now to FIG. 1, method 35 commences with operation 38 in which a record of a real property is received. The record may be that of a foreclosure property sent by a mortgage holder. Once received, the record is stored at operation 41. Depending on the embodiment, the record may be stored within a data store, such as a database or flat file. Further, the method can optionally list the record for review by first or second parties.

At operation 44, the primary party assigns the record to a first party (e.g., intermediary party). Operation 44 may further involve the primary party reviewing and selecting a first party from a list of parties available through the delegation management method. By selecting and assigning the record to a first party, the primary party is effectively engaging the services of the intermediary in handling tasks related to real property to which the record pertains. In some embodiments, the first party has the option to accept or decline a record assigned to them.

Assuming the record has been assigned to a first party that has not declined the assignment, the method receives a request for a task that is associated with the record at operation 47. This request for a task may be received from the primary party or the first party. The requested task is then listed in operation 50 and made available for viewing by potential vendors that may or may not respond to the task. Once responses have been received by the second party in operation 53, the first party can review the response submitted by the second party and respond accordingly. In some embodiments, the response may include an acceptance of the response, a rejection of the response, or a counter-response. As such, a first party and a second party can effectively negotiate through method 35 using these options.

Upon receiving the response from the first party at operation 56, the method 35 stores the response in operation 59. In some embodiments, the method 35 may continue by forwarding the response to the second party, who may or may not begin the task based upon response. For example, if the response was equivalent to an approval of the response, the second party could begin performance of the requested task. Additionally, the requested task may have a predetermined condition associated with it that would result in an automatic transfer of funds to the second party upon being satisfied.

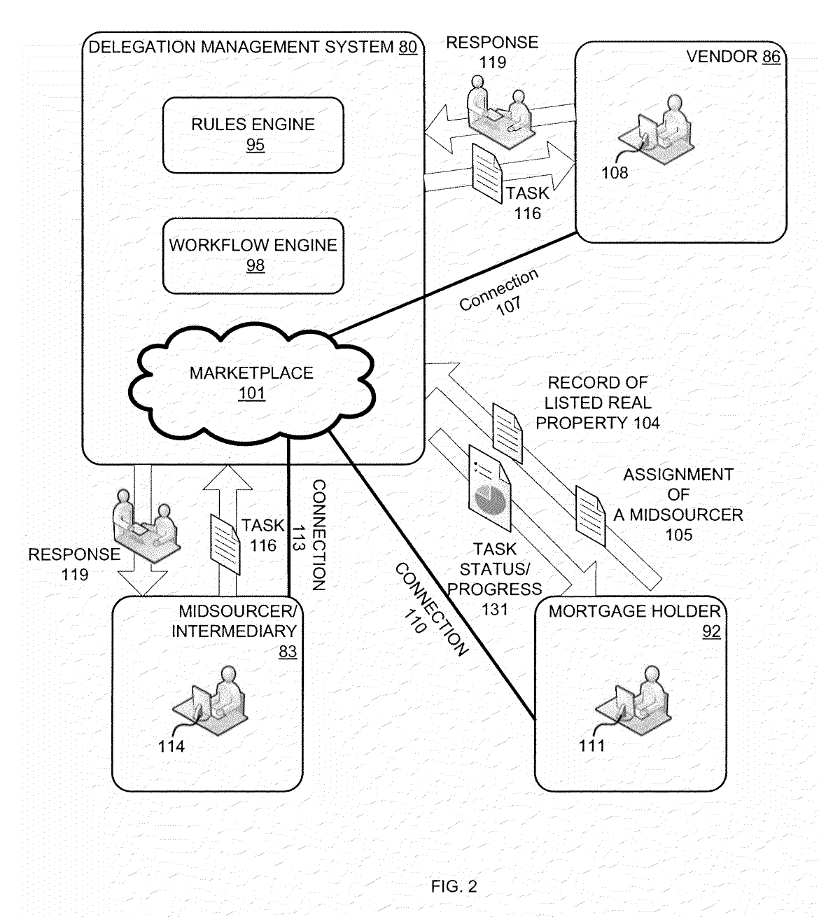

FIG. 2 illustrates a diagram of an example system for delegation management in accordance with an embodiment of the present invention. In the illustrated embodiment, delegation management system 80 comprises a marketplace 101, in which delegation transactions take place; rules engine 95, which is used to enforce business rules against transactions occurring within the marketplace 101; and a workflow engine 96, which ensures that transactions within the marketplace 101 follow the outlined processes.

The midsourcer/intermediary party (i.e., first party) 83, the mortgage holder (i.e., primary party) 92, and the vendor (i.e., the second party) 86 are connected to the marketplace 101 via their respective connections (107, 110, and 113). The connections are attached to a workstation (108, 111, 114) through which each respective party accesses and interacts with the marketplace 101.

For some embodiments, the mortgage holder 92 accesses the marketplace through a master workstation 111, which allows the mortgage holder 92 to add, delete and modify workflows and business rules that are applied against those intermediaries and vendors working on behalf of the mortgage holder. More specifically, the workflows and business rules ensure that marketplace actions performed by the intermediaries and vendors on behalf of the mortgage holder 92 meet the constraints set by the mortgage holder 92. Optionally, the mortgage holder 92 may specify different workflows and business rules for different real property projects under its ownership.

Through the master workstation 111, the mortgage holder 92 is able to send records of real property 104 under their ownership, and send an assignment 105 of such a record to an intermediary/midsourcer. Upon receiving the record 104 and assignment 105, delegation management system 80 will store the record of real property and assignment of an intermediary to the record. Additionally, through the master workstation 111, the mortgage holder 92 can view the status/progress of tasks associated with their specific real property.

In operation, the intermediary 83 and vendor 86 access the marketplace 101 through a subordinate workstation (108, 114), which allows them limited access to only specific tasks or real property listings. Particularly, in some embodiments, the midsourcer/intermediary 83 may only view those real property listings to which they are assigned. Similarly, in some embodiments, the vendor 86 may only view those tasks open for responding and the listings to which they are assigned.

Through the subordinate workstation 114, the midsourcer/intermediary 83 can post a task (i.e., requested task) 116 to the marketplace 101 from which a vendor 86 can browse the task 116 through workstation 108. Subsequently, vendor 86 can respond 119 to the task 116, and the response 119 can be forwarded to the intermediary 83 for review. If the intermediary 83 approves the bid, the task is assigned to the vendor 86. If however, the intermediary 83 does not accept the response 119, the intermediary 83 may reject the response or send a counter-response to the vendor 86. Throughout this entire process, the transactions taking place through the marketplace 101 are verified for compliance by the delegation management system 80 (via rules engine 95 and workflow engine 98). In some embodiments, the response 119 may comprise a bid on the 116 task. In addition, in some embodiments, the response 119 may merely be another task in marketplace 101.

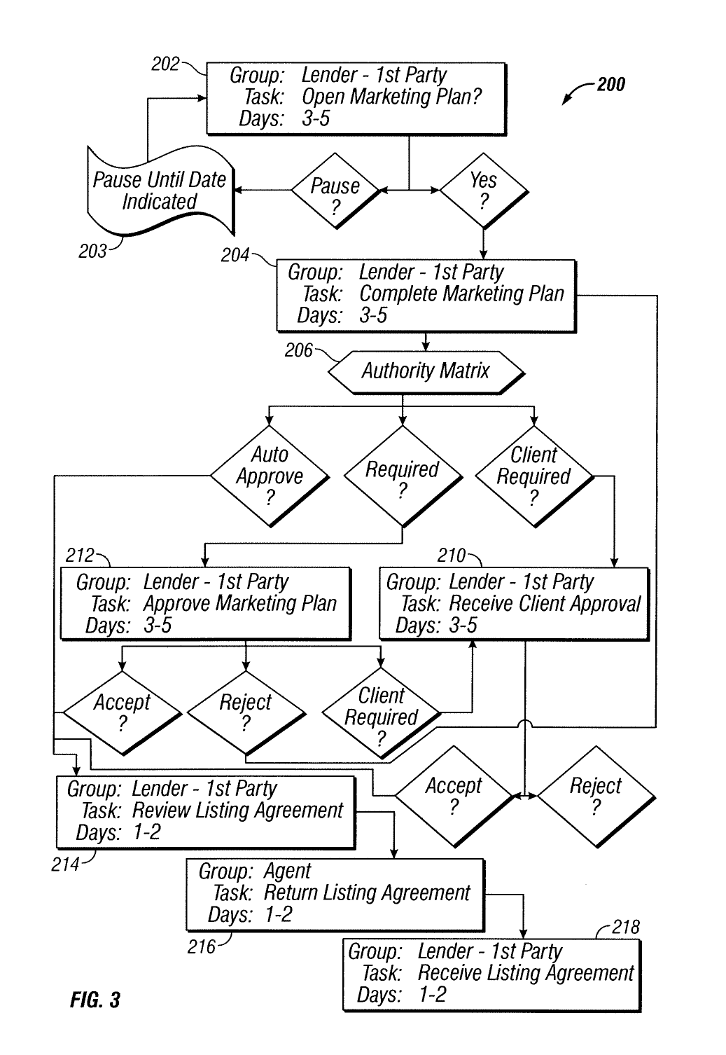

FIG. 3 illustrates a flowchart of an example master workstation workflow 200 under which a delegation management system can operate in accordance with an embodiment of the present invention. In the illustrated example, the first party is operating from a master workstation, while other parties are operating from a subordinate workstation. Referring now to FIG. 3, workflow 200 begins with operation 202, wherein a lender (i.e., the first party) determines whether an open market plan exists. According to workflow 200, the first party may only respond with a “Yes” or, alternatively, pause the task until a specified later date 203. If the first party responds with a “Yes,” the first party may then complete the marketing plan at operation 204. At this point, based on an authority matrix 206, the completed marketing plan produced at operation 204 is either auto approved, approval by the first party, or approval by the client.

If the completed marketing plan requires approval by the first party, the first party, at operation 212, may approve the completed marketing plan, reject the completed marketing plan, or obtain client approval for the completed marketing plan. If the completed marketing plan requires client approval, the first party may receive an approval or rejection from the client at operation 210 and then proceed with the remainder of the workflow 200 accordingly.

When the completed marketing plan is approved by the first party, the client, or automatically, the first party reviews the listing agreement at operation 214 and returns the listing agreement to a listing agent 216. At the end of the workflow 200, the first party receives the final listing agreement at operation 218 from the agent.

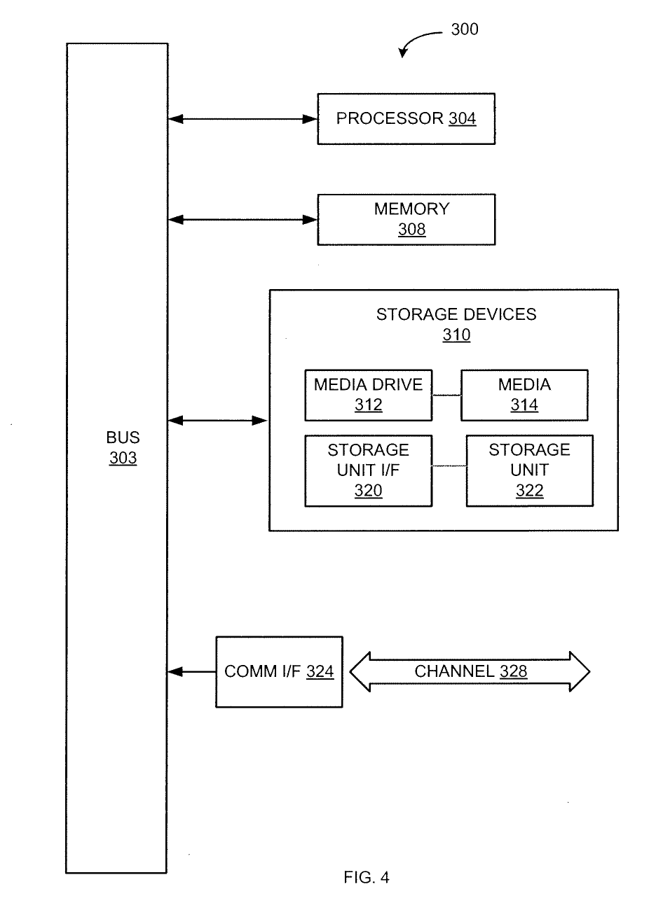

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example-computing module is shown in FIG. 4. Various embodiments are described in terms of this example-computing module 300. After reading this description, it will become apparent to a person skilled in the relevant art how to implement the invention using other computing modules or architectures.

Referring now to FIG. 4, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the example illustrated in FIG. 3, processor 304 is connected to a bus 303, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 303 for storing static information and instructions for processor 304.

The computing module 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a floppy disk drive, a magnetic tape drive, an optical disk drive, a CD or DVD drive (R or RW), or other removable or fixed media drive might be provided. Accordingly, storage media 314, might include, for example, a hard disk, a floppy disk, magnetic tape, cartridge, optical disk, a CD or DVD, or other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable storage medium” are used to generally refer to media such as, for example, memory 308, storage unit 320, media 314, and signals on channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A delegation management system, comprising:
a marketplace within which a first party creates a task and assigns the task to a second party such that the second party can review the task, respond to the task, and accept the task;
a workflow engine configured to ensure that processes for creating, assigning, reviewing, responding to, and accepting the task within the marketplace are performed in accordance with a predefined workflow; and
a rules engine configured to apply a predefined business rule to decisions within the marketplace regarding the task.

2. The delegation management system of claim 1, wherein the second party connects to the marketplace via a subordinate workstation through which the second party can review the task, respond to the task or accept the task.

3. The delegation management system of claim 1, wherein the first party connects to the marketplace via a primary workstation through which the first party can create the task or assign the task.

4. The delegation management system of claim 1, wherein the first party can further add, delete, or modify a business rule.

5. The delegation management system of claim 1, wherein the first party can further add, delete, or modify a predefined workflow.

6. The delegation management system of claim 1, wherein if the second party completes a process outside the predefined workflow or outside the business rule, a request for approval of the process is sent to the first party.

7. The delegation management system of claim 1, wherein the first party is an intermediary party and the second party is a vendor.

8. The delegation management system of claim 7, wherein the vendor is a plumber, pest controller, roofer, painter, pool maintainer, electrician, floor maintainer, carpenter, lawn maintainer, gardener, landscaper or general contractor.

9. The delegation management system of claim 1, wherein a primary party can review a task status or a task progress.

10. The delegation management system of claim 9, wherein the primary party is a mortgage holder or a foreclosure manager.

11. The delegation management system of claim 1, wherein one or more tasks are associated with a real property or a portfolio of real properties.

12. The delegation management system of claim 11, further comprising:
a listing module configured to receive a record of a real property, wherein the record represents a real property; and
a task module configured to manage a task associated with a real property, wherein the first party can create and assign a task associated with the real property.

13. The delegation management system of claim 1, further comprising a response module configured to accept a response from the second party, wherein the response is associated with the task and the first party responsible for the task may either accept or decline the response.

14. The delegation management system of claim 1, wherein the first party can further assign the task to the second party, and wherein the second party can either accept or decline the task.

15. The delegation management system of claim 1, further comprising a task module configured to maintain a task status for a task, wherein the task status can be updated by the first party assigned to the task or the second party assigned to the task.

16. The delegation management system of claim 1, further comprising a payment module configured to track approval of funds and marking of funds for transfer to the second party upon the occurrence of a predetermined condition related to the task.

17. The delegation management system of claim 1, further configured to accept media associated with the task.

18. The delegation management system of claim 1, further configured to provide a secure messaging system between parties.

19. The delegation management system of claim 1, further comprising an authentication module configured to:
determine whether a party can access, edit, delete or add a record on the delegation management system;
allow the first party access to only records relating to a real property to which the first party is assigned; and
allow the second party access only to records relating to a task to which the second party is assigned.

20. A computer program product having instructions embedded in a computer useable medium, the instructions configured to cause a processor to perform the operations of:
receiving a record of a real property from a primary party;
storing the record on a computer useable medium;
assigning the record to a first party;
receiving a request for a task from the first party, wherein the task is associated with the record;
listing the task such that a second party can respond to the task;
receiving a response to the task from the second party;
forwarding the response to the first party for review;
receiving an acceptance or rejection of the response from the first party; and
storing the acceptance or rejection on a computer usable storage medium.
